(19) United States
(12) Patent Application Publication
(10) Pub. No.: US 2008/0066636 A1
(43) Pub. Date: Mar. 20, 2008

(54) Image Generating Apparatus

(75) Inventor: Noriyuki SHIMIZU, Daito-shi (JP)

Correspondence Address: CROWELL & MORING LLP;INTELLECTUAL PROPERTY GROUP, P.O. BOX 14300, WASHINGTON, DC, 20044-4300, US

(73) Assignee: Funai Electric Co., Ltd., Daito-shi (JP)

(21) Appl. No.: 11/854,767

(22) Filed: Sep. 13, 2007

(30) Foreign Application Priority Data
Sep. 15, 2006 (JP) 2006-007492

(51) Int. Cl. B41F 13/12

(52) U.S. Cl. 101/375

(57) ABSTRACT

Obtained is an image generating apparatus capable of suppressing increase in the number of components and inhibiting a rotating member from slipping off an apparatus body by an abrupt external impact or vibration in a nonprinting state including a state in transportation. This sublimating printer (image generating apparatus) includes a printer body including a chassis having an engaging portion and a rotating member, provided inside the chassis, integrally including rotating shafts on both ends thereof while also integrally including a protrusion engaging with the engaging portion of the chassis in a printing standby state (nonprinting state).

### BACKGROUND OF THE INVENTION

1. Field of the Invention

The present invention relates to an image generating apparatus, and more particularly, it relates to an image generating apparatus comprising an apparatus body including a chassis.

2. Description of the Background Art

An image generating apparatus comprising an apparatus body including a chassis is known in general, as disclosed in Japanese Patent Laying-Open No. 2005-319600, 2000-272193 or 5-155100 (1993), for example.

The aforementioned Japanese Patent Laying-Open No. 2005-319600 discloses an image generating apparatus comprising a vertically rotatable thermal head, a platelike lever slidable back and forth and provided with a hook for fixing and releasing the thermal head and an openable/closable door provided on the front surface of the apparatus body for allowing the user to operate the platelike lever. This image generating apparatus is so formed that the platelike lever urged by a spring slides toward the front side and the hook provided thereon so rotates as to engage with a rotating arm of the thermal head thereby fixing the thermal head when the user opens the door provided on the front surface of the apparatus body (nonprinting state for exchanging an ink cartridge or the like). When the user closes the door (printing state), on the other hand, the platelike lever in contact with the door is pressed to slide toward the rear side of the apparatus body and the hook provided thereon rotates in the opposite direction thereby releasing the thermal head from the fixed state.

The aforementioned Japanese Patent Laying-Open No. 2000-272193 discloses a printer (image generating apparatus) comprising a vertically rotatable print head, a lever provided with a hook on the forward end thereof and rotatably supported by a side frame of a printer body supporting the print head and an engaging pin provided on a lower frame of the printer body rotatably supporting a platen roller pressed against the print head. This printer (image generating apparatus) is so formed that the hook of the lever engages with the engaging pin of the lower frame in association with an operation of the user lowering the print head and setting the same on a printing position, thereby fixing the print head to the printing position. When the user lifts up the print head, on the other hand, a roller provided on a head frame rotating with the print head comes into contact with the lever having engaged with the engaging pin of the lower frame and pushes up the lever, thereby releasing the hook from the engagement with the engaging pin.

The aforementioned Japanese Patent Laying-Open No. 5-155100 discloses a thermal transfer image generating apparatus (image generating apparatus) comprising a thermal head supported on external frames (chassis) of an apparatus body and urged by a spring in a constant direction, a platen roller rotatably supported by the left and right external frames (chassis) of the apparatus body, bearings provided on both ends of the platen roller and two positioning plates provided on both ends of the thermal head for coming into contact with the two bearings corotating with the platen roller. This thermal transfer image generating apparatus (image generating apparatus) is so formed that the positioning plates of the thermal head are regularly in contact with the bearings of the platen roller so that the thermal head can follow horizontal deviation of a rotating shaft of the platen roller resulting from vibration of the apparatus body.

In the conventional image generating apparatus proposed in the aforementioned Japanese Patent Laying-Open No. 2005-319600, however, the apparatus body is provided with a mechanism for fixing the thermal head by interlocking two members, i.e., the platelike lever and the hook provided thereon in the nonprinting state, whereby the number of components is disadvantageously increased. Further, the conventional image generating apparatus proposed in the aforementioned Japanese Patent Laying-Open No. 2005-319600 conceivably neither discloses nor suggests a structure for inhibiting a rotating member including the thermal head from slipping off the apparatus body. Therefore, the rotating member including the thermal head may slip off the apparatus body due to abrupt external impact or vibration in the nonprinting state including a state in transportation.

In the conventional printer proposed in the aforementioned Japanese Patent Laying-Open No. 2000-272193, the lever must be provided on the side frame of the printer body for fixing the print head and the roller for pushing up the lever must be provided on the head frame of the print head for releasing the print head from the fixed state, whereby the number of components forming the mechanism for fixing the print head and releasing the same from the fixed state is disadvantageously increased.

The conventional thermal transfer image generating apparatus proposed in the aforementioned Japanese Patent Laying-Open No. 5-155100 conceivably neither discloses nor suggests a structure for inhibiting a rotating member for supporting the thermal head and repetitively pressing and separating the same against and from the platen roller etc. from slipping off the apparatus body. Therefore, the rotating member including the thermal head etc. may slip off the apparatus body due to abrupt external impact or vibration in the nonprinting state including a state in transportation.

### SUMMARY OF THE INVENTION

The present invention has been proposed in order to solve the aforementioned problems, and an object of the present invention is to provide an image generating apparatus capable of suppressing increase in the number of components and inhibiting a rotating member from slipping off an apparatus body by abrupt external impact or vibration in a nonprinting state including a state in transportation.

An image generating apparatus according to a first aspect of the present invention comprises an apparatus body including a chassis having an engaging portion and a rotating member, provided inside the chassis, integrally including rotating shafts on both ends thereof while also integrally including a protrusion engaging with the engaging portion of the chassis in a nonprinting state.

As hereinabove described, the image generating apparatus according to the first aspect of the present invention comprises the apparatus body including the chassis having the engaging portion and the rotating member, provided inside the chassis, including the protrusion engaging with the engaging portion of the chassis in the nonprinting state so that the protrusion of the rotating member can engage with the engaging portion of the chassis when the rotating member supported on the chassis rests on a rotational position for the nonprinting state (in transportation or a printing standby state), whereby the rotating member can be kept in the state supported on the chassis due to the engagement with the chassis even if force is applied in a direction for displacing the chassis from the rotating member by an abrupt impact or vibration received from outside the apparatus body. Thus, the rotating member can be inhibited from slipping off the apparatus body in the nonprinting state (in transportation or the printing standby state). Further, the rotating member is so formed as to integrally include the rotating shafts on both ends thereof and to also integrally include the protrusion engaging with the engaging portion of the chassis in the nonprinting state so that the apparatus body may not be provided with rotating shafts for rotating the rotating member or a member or a mechanism for engaging with the engaging portion of the chassis independently of the rotating member, whereby the number of components can be inhibited from increase.

In the aforementioned image generating apparatus according to the first aspect, the chassis preferably has a first side surface and a second side surface as well as a bottom surface connecting the first side surface and the second side surface with each other, the engaging portion of the chassis is preferably provided on at least either the first side surface or the second side surface of the chassis to inwardly protrude into the chassis, and the protrusion of the rotating member is preferably inserted into the engaging portion along with rotation of the rotating member, thereby engaging with the engaging portion. According to this structure, the protrusion of the rotating member having the rotating shafts provided on both ends thereof and supported on the first and second side surfaces of the chassis can easily engage with the engaging portion provided inside the chassis along with rotation of the rotating member.

In this case, the engaging portion of the chassis preferably has a position control portion controlling the position of the engaging portion when engaging with the protrusion of the rotating member, and the position control portion is preferably arranged substantially parallelly to at least either the first side surface or the second side surface of the chassis at a prescribed distance. According to this structure, the position control portion arranged substantially parallelly to the first side surface and/or the second side surface of the chassis comes into contact with the protrusion of the rotating member thereby controlling the position of the engaging portion, even if the first and second side surfaces of the chassis are outwardly inclined (deformed) from the chassis in directions for slipping off the rotating member. Thus, the first and second side surfaces of the chassis can be easily inhibited from outward inclination (deformation) from the chassis.

In the aforementioned image generating apparatus according to the first aspect, the chassis preferably has a first side surface and a second side surface as well as a bottom surface connecting the first side surface and the second side surface with each other, and the protrusions of the rotating member are preferably provided on both ends of the rotating member, while the engaging portions of the chassis are preferably provided on both of the first side surface and the second side surface. According to this structure, the protrusions of the rotating member can engage with the engaging portions of the chassis on the first and second side surfaces of the chassis respectively. Thus, the rotating member can be inhibited from slipping off both of the first and second side surfaces.

In this case, the engaging portions of the chassis preferably have position control portions controlling the positions of the engaging portions when engaging with the protrusions of the rotating member, and the protrusions of the rotating member preferably rotate integrally with the rotating member along a plane substantially parallel to at least either the first side surface or the second side surface of the chassis, to be inserted into clearances between at least either the first side surface or the second side surface of the chassis and the position control portions. According to this structure, the protrusions of the rotating member can rotate substantially in the same plane with respect to the position control portions of the engaging portions, whereby the protrusions of the rotating member can reliably engage with the engaging portions of the chassis in an opposed state respectively.

In the aforementioned image generating apparatus according to the first aspect, the chassis preferably has a first side surface and a second side surface as well as a bottom surface connecting the first side surface and the second side surface with each other, the first side surface and the second side surface of the chassis are preferably provided with support portions rotatably supporting the rotating shafts of the rotating member, and the engaging portion of the chassis is preferably provided in the vicinity of the support portions. According to this structure, the rotating shafts of the rotating member and the engaging portion of the chassis are so approximate to each other that the support portions of the chassis can be immediately inhibited from inclination (deformation) resulting from an abrupt impact or vibration when the protrusion of the rotating member engages with the engaging portion of the chassis (nonprinting state).

In the aforementioned image generating apparatus according to the first aspect, the chassis preferably has a first side surface and a second side surface as well as a bottom surface connecting the first side surface and the second side surface with each other, the chassis is preferably made of sheet metal, and the engaging portion of the chassis is preferably integrally provided on at least either the first side surface or the second side surface of the chassis by partially uprighting at least either the first side surface or the second side surface. According to this structure, the engaging portion provided on the first or second side surface of the chassis can be easily formed at the same time when the chassis of sheet metal is formed by press working.

In this case, the rotating member integrally including the protrusion engaging with the engaging portion of the chassis is preferably provided inside the chassis, and the engaging portion of the chassis is preferably so formed that a first side thereof is connected to at least either the first side surface or the second side surface and a second side corresponding to the rotational direction of the protrusion of the rotating member is open. According to this structure, the engaging portion having the open second side can be improved in strength also when the same is formed by uprighting a sheet metal member.

In the aforementioned image generating apparatus according to the first aspect, the rotating member integrally including the rotating shafts and the protrusion is preferably made of sheet metal. According to this structure, the rotating member can be prepared from a platelike member previously integrally provided with a protrusion by bending. Further, the rotating shafts can also be easily provided by performing press working such as burring on portions for forming both ends of the rotating member in a pre-step for bending a sheet metal member (rotating member).

An image generating apparatus according to a second aspect of the present invention comprises an apparatus body including a chassis having engaging portions and a rotating member, provided inside the chassis, integrally including rotating shafts on both ends thereof while also integrally including protrusions engaging with the engaging portions of the chassis in a nonprinting state, while the chassis is made of sheet metal, and has a first side surface and a second side surface as well as a bottom surface connecting the first side surface and the second side surface with each other, the engaging portions of the chassis are integrally provided on the first side surface and the second side surface of the chassis by partially uprighting the first side surface and the second side surface of the chassis respectively, to inwardly protrude into the chassis, and the protrusions provided on both ends of the rotating member are inserted into the engaging portions along with rotation of the rotating member, thereby engaging with the engaging portions.

In the image generating apparatus according to the second aspect, as hereinabove described, the chassis has the engaging portions while the rotating member including the protrusions engaging with the engaging portions of the chassis in the nonprinting state is provided inside the chassis so that the protrusions of the rotating member can engage with the engaging portions of the chassis when the rotating member supported on the chassis rests on a rotational position for the nonprinting state (in transportation or a printing standby state), whereby the rotating member can be kept in the state supported on the chassis due to the engagement with the chassis even if force is applied in a direction for displacing the chassis from the rotating member due to an abrupt impact or vibration received from outside the apparatus body. Thus, the rotating member can be inhibited from slipping off the apparatus body in the nonprinting state (in transportation or the printing standby state). Further, the rotating member is so formed as to integrally include the rotating shafts on both ends thereof and to also integrally include the protrusions engaging with the engaging portions of the chassis in the nonprinting state so that the apparatus body may not be provided with rotating shafts for rotating the rotating member or members or mechanisms for engaging with the engaging portions of the chassis independently of the rotating member, whereby the number of components can be inhibited from increase.

In the image generating apparatus according to the second aspect, further, the engaging portions of the chassis are provided on the first and second side surfaces of the chassis to inwardly protrude into the chassis while the protrusions of the rotating member are inserted into the engaging portions along with rotation of the rotating member thereby engaging with the engaging portions, whereby the protrusions of the rotating member having the rotating shafts provided on both ends thereof and supported on the first and second side surfaces of the chassis can easily engage with the engaging portions provided inside the chassis along with rotation of the rotating member. Further, the protrusions of the rotating member are provided on both ends of the rotating member while the engaging portions of the chassis are provided on both of the first and second side surfaces, whereby the protrusions of the rotating member can engage with the engaging portions of the chassis on the first and second side surfaces of the chassis respectively. Thus, the rotating member can be inhibited from slipping off both of the first and second side surfaces.

In the image generating apparatus according to the second aspect, the chassis is made of sheet metal while the engaging portions of the chassis are integrally provided on the first and second side surfaces of the chassis by partially uprighting the first and second side surfaces respectively, whereby the engaging portions of the first and second side surfaces of the chassis can be easily formed at the same time when the chassis of sheet metal is formed by press working. Further, the rotating member integrally including the rotating shafts and the protrusions is also made of sheet metal, so that the rotating member can be prepared from a platelike member previously integrally provided with protrusions by bending. Further, the rotating shafts can also be easily provided by performing press working such as burring on portions for forming both ends of the rotating member in a pre-step for bending a sheet metal member (rotating member).

In the aforementioned image generating apparatus according to the second aspect, the engaging portions of the chassis preferably have position control portions controlling the positions of the engaging portions when engaging with the protrusions of the rotating member, and the position control portions are preferably arranged substantially parallelly to at least either the first side surface or the second side surface of the chassis at prescribed distances. According to this structure, the position control portions arranged substantially parallelly to the first side surface and/or the second side surface of the chassis come into contact with the protrusions of the rotating member thereby controlling the positions of the engaging portions, even if the first and second side surfaces of the chassis are outwardly inclined (deformed) from the chassis in directions for slipping off the rotating member. Thus, the first and second side surfaces of the chassis can be easily inhibited from outward inclination (deformation) from the chassis.

In the aforementioned image generating apparatus according to the second aspect, the engaging portions of the chassis preferably have position control portions controlling the positions of the engaging portions when engaging with the protrusions of the rotating member, and the protrusions of the rotating member preferably rotate integrally with the rotating member along a plane substantially parallel to at least either the first side surface or the second side surface of the chassis, to be inserted into clearances between at least either the first side surface or the second side surface of the chassis and the position control portions. According to this structure, the protrusions of the rotating member can rotate substantially in the same plane with respect to the position control portions of the engaging portions, whereby the protrusions of the rotating member can reliably engage with the engaging portions of the chassis in an opposed state respectively.

In the aforementioned image generating apparatus according to the second aspect, the first side surface and the second side surface of the chassis are preferably provided with support portions rotatably supporting the rotating shafts of the rotating member, and the engaging portions of the chassis are preferably provided in the vicinity of the support portions. According to this structure, the rotating shafts of the rotating member and the engaging portion of the chassis are so approximate to each other that the support portions of the chassis can be immediately inhibited from inclination (deformation) resulting from an abrupt impact or vibration when the protrusions of the rotating member engage with the engaging portions of the chassis (nonprinting state).

In the aforementioned image generating apparatus according to the second aspect, the engaging portions of the chassis are preferably so formed that first sides thereof are connected to at least either the first side surface or the second side surface and second sides corresponding to the rotational direction of the protrusions of the rotating member are open. According to this structure, the engaging portions having the open second sides can be improved in strength also when the same are formed by uprighting sheet metal members.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is an exploded perspective view showing the overall structure of a sublimatic printer according to an embodiment of the present invention;

FIG. 2 is a perspective view of the sublimatic printer according to the embodiment of the present invention shown in FIG. 1;

FIG. 3 is a sectional view showing the internal structure of the sublimatic printer according to the embodiment of the present invention shown in FIG. 1;

FIG. 4 illustrates arrangement of gears in the sublimatic printer according to the embodiment of the present invention shown in FIG. 1;

FIG. 5 is a plan view of the sublimatic printer according to the embodiment of the present invention shown in FIG. 1;

FIG. 6 is a front elevational view of the sublimatic printer according to the embodiment of the present invention shown in FIG. 1;

FIGS. 7 to 9 are perspective views showing the structures of a rotating member and head portion pressing members in the sublimatic printer according to the embodiment of the present invention shown in FIG. 1;

FIGS. 10 and 11 illustrate a chassis of the sublimatic printer according to the embodiment of the present invention shown in FIG. 1;

FIG. 12 illustrates an engaging state between the rotating member and the chassis of the sublimatic printer according to the embodiment of the present invention shown in FIG. 1;

FIG. 13 illustrates a disengaging state between the rotating member and the chassis of the sublimatic printer according to the embodiment of the present invention shown in FIG. 1;

FIGS. 14 to 16 are sectional views for illustrating rotation of a print head in a printing operation of the sublimatic printer according to the embodiment of the present invention shown in FIG. 1;

FIG. 17 is a perspective view showing the structure of a rotating member of a sublimatic printer according to a modification of the embodiment of the present invention; and

FIG. 18 is a perspective view of the sublimatic printer according to the modification of the embodiment of the present invention.

### DESCRIPTION OF THE PREFERRED EMBODIMENTS

An embodiment of the present invention is now described with reference to the drawings.

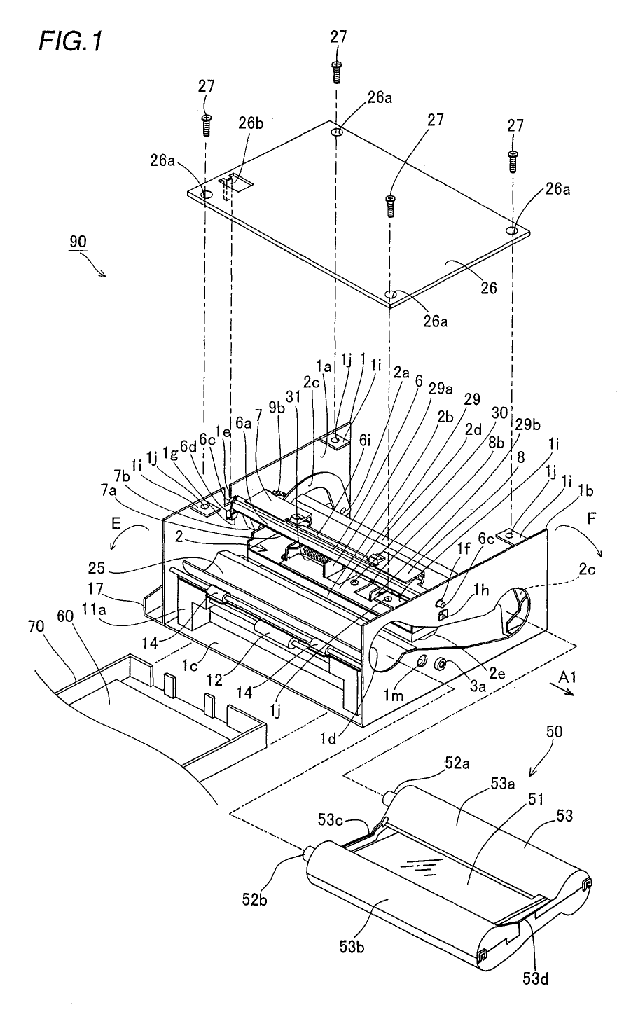

The structure of a sublimatic printer according to the embodiment of the present invention is described with reference to FIGS. 1 to 3. This embodiment is applied to the sublimatic printer, which is an exemplary image generating apparatus.

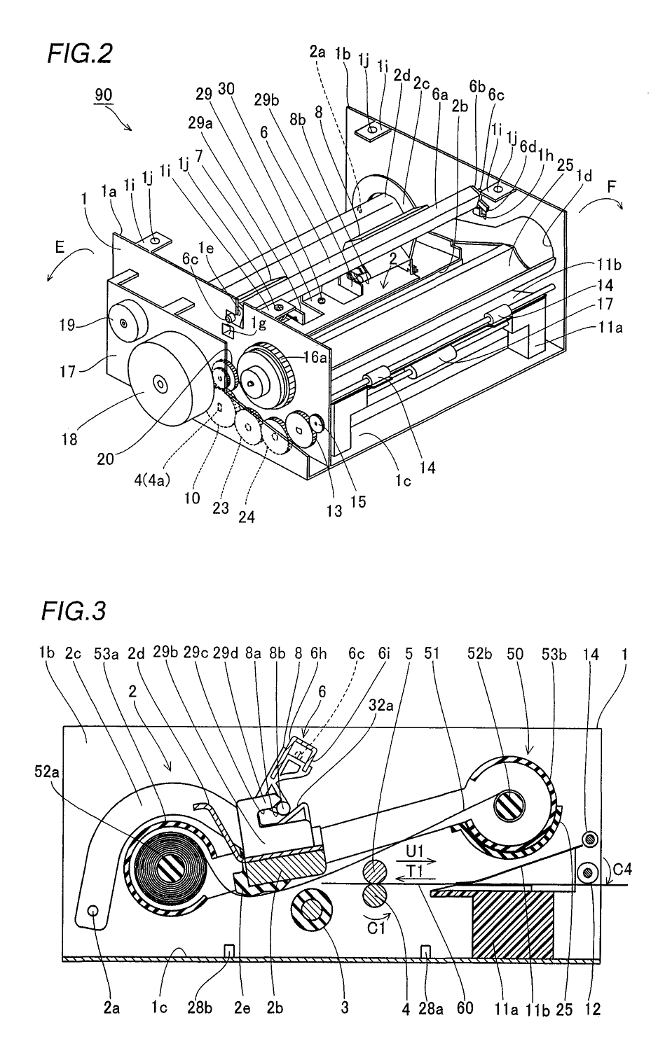

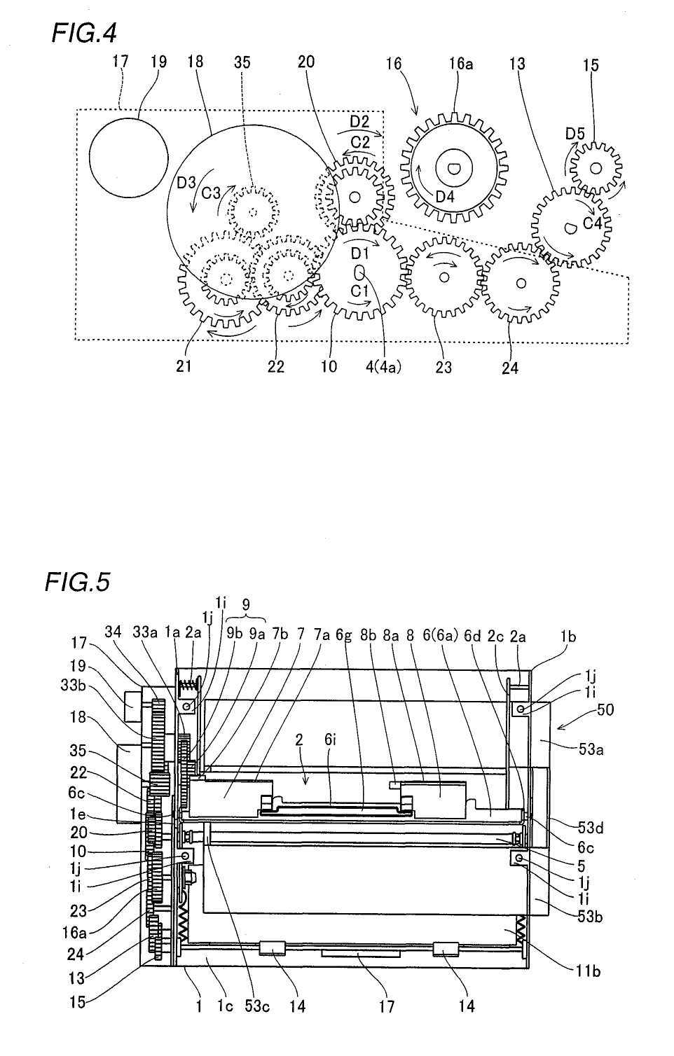

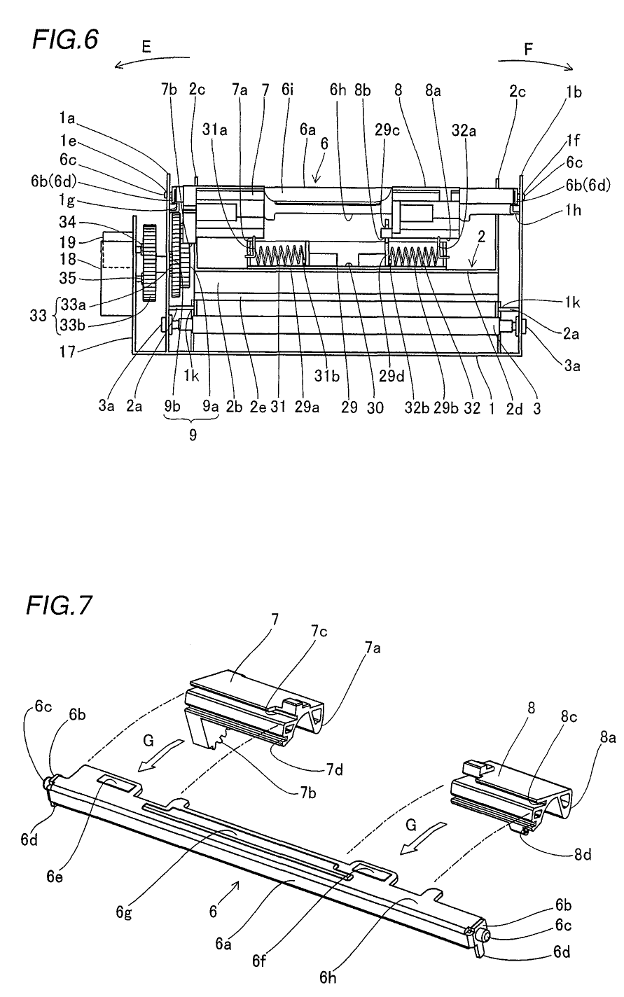

A printer body 90 of the sublimatic printer according to the embodiment comprises a chassis 1 of metal (sheet metal), a print head 2 for printing, a platen roller 3 (see FIG. 3) opposed to the print head 2, a feed roller 4 (see FIG. 3) of metal, a press roller 5 (see FIG. 3) of metal pressing the feed roller 4 with prescribed pressing force, a rotating member 6 of sheet metal, head portion pressing members 7 and 8 of resin for pressing the print head 2, a driving gear 9 (see FIG. 6) of resin, a feed roller gear 10 (see FIG. 4), a lower paper guide 11a of resin, an upper paper guide 11b (see FIG. 3) of resin, a paper feed roller 12 of rubber, a paper feed roller gear 13 (see FIG. 2), a paper discharge roller 14 of rubber, a paper discharge roller gear 15 (see FIG. 2), a take-up reel 16 (see FIG. 2), a motor bracket 17 (see FIG. 2) of sheet metal, a stepping motor 18 (see FIG. 2) for transporting papers 60, another stepping motor 19 (see FIG. 2) serving as a driving source for rotating the print head 2, a swingable swing gear 20 (see FIG. 4), a plurality of intermediate gears 21 to 24 (see FIG. 4), a cartridge support portion 25 supporting an ink sheet cartridge 50 storing an ink sheet 51 and a top plate 26, as shown in FIG. 1. The ink sheet cartridge 50 and a paper feed cassette case 70 for storing the papers 60 fed to the sublimatic printer are detachably mounted on the sublimatic printer according to this embodiment.

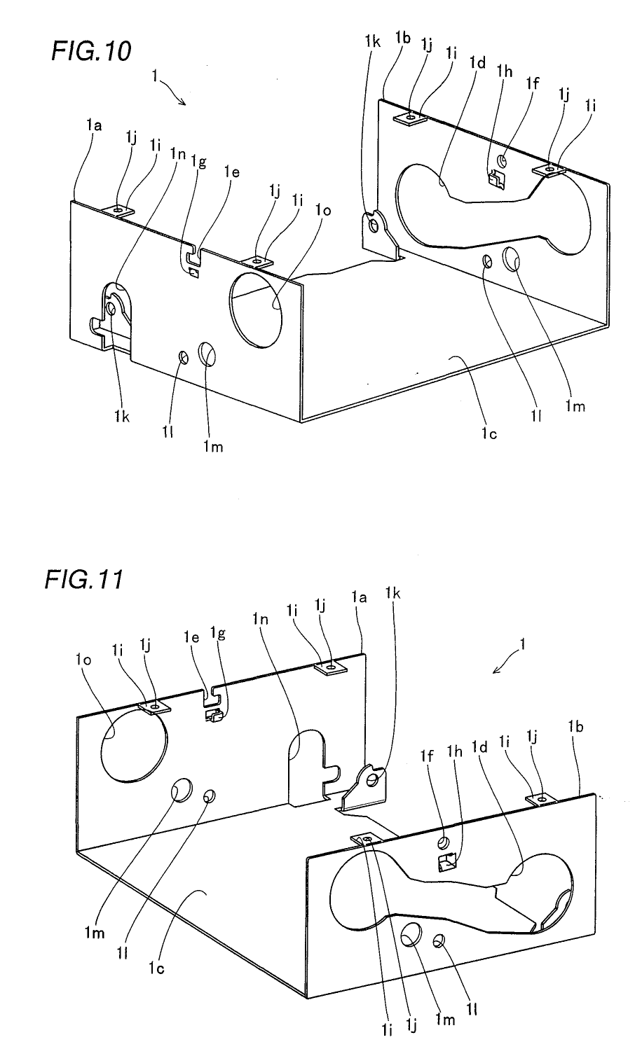

The chassis 1 has first and second side surfaces 1a and 1b opposed to each other and a bottom surface 1c, as shown in FIGS. 1 and 10. The aforementioned motor bracket 17 is mounted on the first side surface 1a of the chassis 1, as shown in FIG. 2. The second side surface 1b of the chassis 1 opposed to the first side surface 1a is provided with a cartridge receiving hole 1d for receiving the ink sheet cartridge 50, as shown in FIGS. 1 and 10. The first side surface 1a of the chassis 1 is provided with a support portion 1e formed by notching a position opposed to a first rotating shaft 6c of the rotating member 6 in an L-shaped manner in order to rotatably support the rotating member 6 mounted with the head portion pressing members 7 and 8, as shown in FIGS. 1 and 10. Further, the second side surface 1b of the chassis 1 is provided with a support hole 1f rotatably supporting the rotating member 6 mounted with the head portion pressing members 7 and 8 for rotatably receiving a second rotating shaft 6c of the rotating member 6, as shown in FIGS. 1 and 10.

According to this embodiment, an engaging portion 1g whose horizontal and vertical sections are both L-shaped is integrally provided in the vicinity of a portion located under the support portion 1e of the first side surface 1a of the chassis 1, as shown in FIG. 10. This engaging portion 1g is so provided as to inwardly protrude into the chassis 1 by partially cutting the first side surface 1a of the chassis 1 in the form of an L-shaped slit and press-working the inner portion of the L-shaped slit. Thus, a position control portion is formed inside the engaging portion 1g substantially parallelly to the first side surface 1a of the chassis 1 at a prescribed distance (slightly larger than the thickness of a protrusion 6d (see FIG. 9) of sheet metal). The engaging portion 1g is so formed that a first side thereof is connected to the first side surface 1a while a second side corresponding to the rotational direction (substantially obliquely downward direction) of the protrusion 6d (see FIG. 9) is open toward the support portion 1e (obliquely upward direction as viewed from the engaging portion 1g), as shown in FIG. 11.

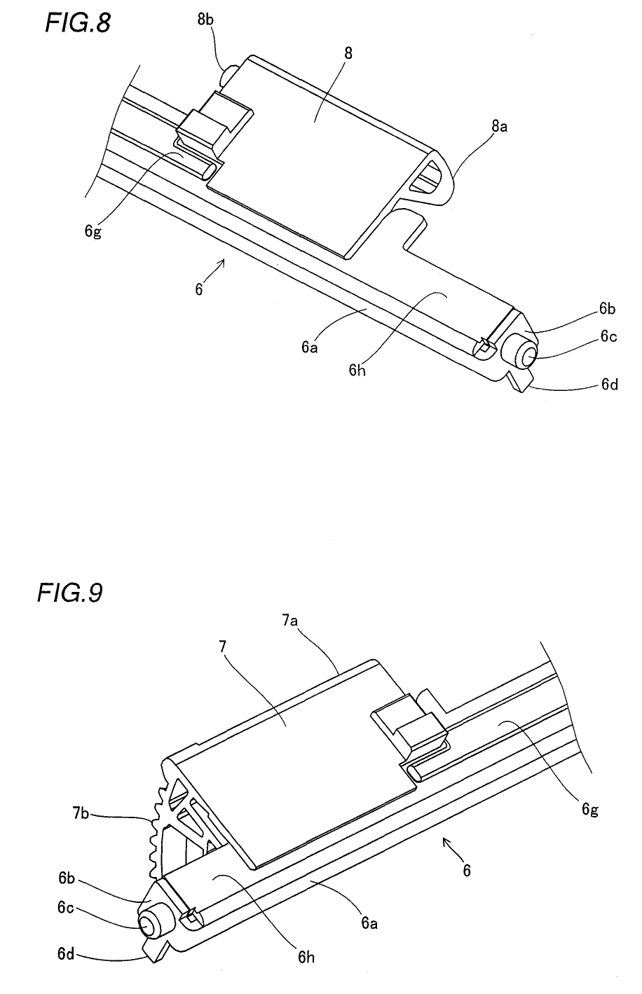

According to this embodiment, another engaging portion 1h whose horizontal and vertical sections are both L-shaped is integrally provided in the vicinity of a portion located under the support hole if of the second side surface 1b of the chassis 1, as shown in FIG. 11. This engaging portion 1h is also so provided as to inwardly protrude into the chassis 1, similarly to the aforementioned engaging portion 1g. Thus, another position control portion is formed inside the engaging portion 1h substantially parallelly to the second side surface 1b of the chassis 1 at a prescribed distance (slightly larger than the thickness of another protrusion 6d (see FIG. 8) of sheet metal). The engaging portion 1h is so formed that a first side thereof is connected to the second side surface 1b while a second side corresponding to the rotational direction (substantially obliquely downward direction) of the protrusion 6d (see FIG. 13) is open toward the support hole 1f (obliquely upward direction as viewed from the engaging portion 1h), as shown in FIGS. 10 and 13.

As shown in FIG. 1, two pairs of mounting portions 1i for mounting the top plate 26 are provided on the upper ends of the first and second side surfaces 1a and 1b of the chassis 1 respectively. The four mounting portions 1i of the chassis 1 are provided with threaded holes 1j for fixing the top plate 26 to the chassis 1 by passing screws 27 through four holes 26a provided in the top plate 26. When the top plate 26 is mounted on the chassis 1, a stop portion 26b integrally provided on the top plate 26 by partially uprighting the same is inserted into the L-shaped support portion 1e provided on the first side surface 1a of the chassis 1, so that the rotating member 6 is rotatably supported on the chassis 1, not to slip off the chassis 1.

The first side surface 1a of the chassis 1 is provided with a shaft receiving hole 1k for receiving one of support shafts 2a of the print head 2 described later, as shown in FIG. 10. The first and second side surfaces 1a and 1b are provided with support holes 1l and 1m for rotatably supporting the platen roller 3 (see FIG. 3) and the feed roller 4 see FIG. 3) respectively. Further, the first side surface 1a of the chassis 1 is provided with a notch in for arranging a supply bobbin support portion (not shown) supporting a supply bobbin 52a (see FIG. 1) of the ink sheet cartridge 50 described later and a receiving hole 1o rotatably receiving the take-up reel 16 (see FIG. 1) supporting a take-up bobbin 52b (see FIG. 1) of the ink sheet cartridge 50, as shown in FIG. 11. The bottom surface 1c of the chassis 1 is provided with paper sensors 28a and 28b for sensing the front and rear ends of each paper 60 respectively in printing, as shown in FIG. 3.

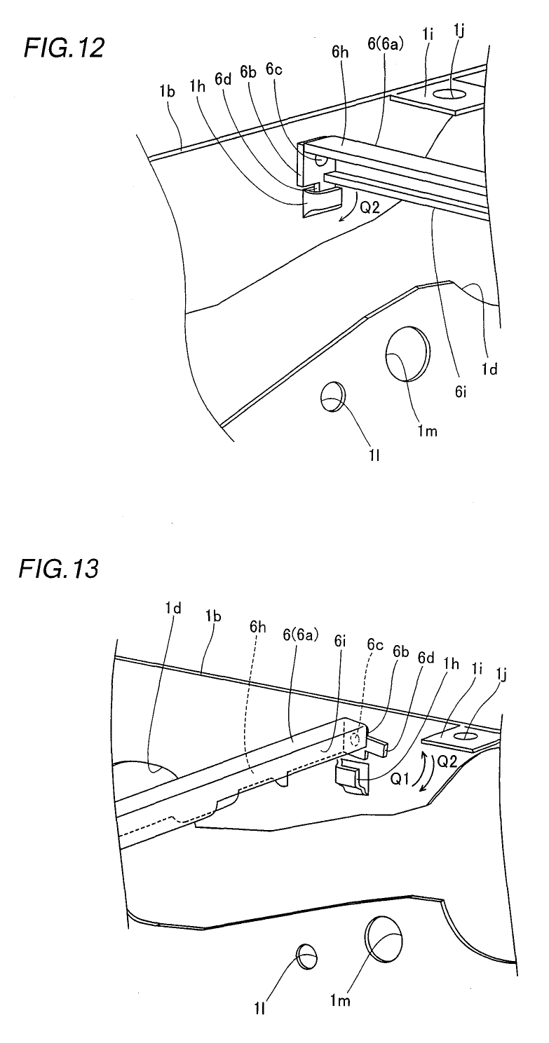

According to this embodiment, the rotating member 6 is provided with a shaft portion 6a formed by folding a sheet metal member into the form of a box while the pair of rotating shafts 6c are integrally provided on first and second end surfaces 6b of the shaft portion 6a by press working such as burring, as show in FIG. 7. The end surfaces 6b are examples of the “both ends” in the present invention. Further, the platelike protrusions 6d having the same thickness as the end surfaces 6b are integrally provided on the first and second end surfaces 6b of the shaft portion 6a to protrude in the direction perpendicular to the rotating shafts 6c respectively, as shown in FIGS. 8 and 9. When the rotating member 6 rotates along arrow Q2 (see FIG. 12) with the head portion pressing members 7 and 8 (see FIG. 1), the two protrusions 6d integrally rotate along planes substantially parallel to the first and second side surfaces 1a and 1b of the chassis 1 to be inserted into the engaging portions 1g (see FIG. 1) and 1h (see FIG. 12) provided on the first and second side surfaces 1a and 1b respectively, as shown in FIGS. 1 and 12. Thus, the two protrusions 6d can engage with the engaging portions 1g (see FIG. 1) and 1h (see FIG. 12) while controlling the positions thereof by coming into contact with the position control portions provided inside the engaging portions 1g (see FIG. 1) and 1h (see FIG. 12) in an opposed state respectively. Referring to FIG. 12, illustration of the head portion pressing member 8 mounted on the rotating member 6 is omitted, in order to clearly show the engaging state between the engaging portion 1h of the chassis 1 and the corresponding protrusion 6d of the rotating member 6.

When the printer body 90 according to this embodiment is assembled, the first rotating shaft 6c of the rotating member 6 is inserted into the support hole if of the chassis 1 and the second rotating shaft 6c is inserted into the support portion 1e (see FIG. 1) of the chassis 1 along the L-shape thereof on such a rotational position (rotation angle) of the rotating member 6 that the two protrusions 6d thereof do not yet engage with the engaging portions 1g and 1h of the chassis 1, as shown in FIG. 13. After the printer body 90 is completely assembled, power for inspection is supplied in the state shown in FIG. 13 for driving the stepping motor 19 (see FIG. 2) so that the rotating member 6 automatically rotates to the initial position (printing standby state) along arrow Q2, as shown in FIG. 12. Also in this case, the protrusions 6d of the rotating member 6 can be inserted into the engaging portions 1g (see FIG. 1) and 1h (see FIG. 12) provided on the first and second side surfaces 1a and 1b of the chassis 1, for engaging with the engaging portions 1g (see FIG. 1) and 1h (see FIG. 12) respectively.

Hook portions 6e and 6h for mounting the head portion pressing members 7 and 8 respectively are integrally provided on the shaft portion 6a by press working, as shown in FIG. 7. A projecting portion 6g for ensuring rigidity of the shaft portion 6a is provided in the vicinity of the center of the shaft portion 6a held between the hook portions 6e and 6f by press working, as shown in FIG. 7. Further, the shaft portion 6a includes a first side surface 6h having the hook portions 6e and 6f as shown in FIG. 7, and a second side surface 6i opposed to the first side surface 6h as shown in FIGS. 3 and 5.

Two platen roller bearings 3a are mounted on the support holes 1l provided on the first and second side surfaces 1a and 1b of the chassis 1 respectively as shown in FIGS. 1 and 6, for rotatably supporting the platen roller 3 (see FIG. 3). The feed roller 4 has a feed roller insertion portion 4a inserted into the feed roller gear 10, as shown in FIG. 4. The feed roller 4 is rotatably supported by a feed roller bearing (not shown) mounted on the support holes 1m of the chassis 1. The press roller 5 (see FIG. 3) is rotatably supported by a press roller bearing (not shown). The feed roller 4 and the press roller 5 have a function of transporting each paper 60 in a paper feed direction (along arrow T1) or a paper discharge direction (along arrow U1) by rotating while holding the paper 60 therebetween, as shown in FIG. 3. The paper feed roller 12 has a function of transporting each paper 60 stored in the paper feed cassette case 70 (see FIG. 1) into the chassis 1.

The head portion pressing member 7 is integrally provided with a pressing portion 7a and a gear portion 7b, as shown in FIG. 7. The head portion pressing member 7 is further integrally provided with groove portions 7c and 7d so that the hook portion 6e and the second side surface 6i (see FIG. 3) of the rotating member 6 are press-fitted into these groove portions 7c and 7d respectively when the head portion pressing member 7 is mounted on the rotating member 6 along arrow G in FIG. 7, as shown in FIG. 7. On the other hand, the head portion pressing member 8 is integrally provided with a pressing portion 8a and a protrusion 8b protruding in the extensional direction of the rotating member 6, as shown in FIG. 8. The head portion pressing member 8 is further integrally provided with groove portions 8c and 8d so that the hook portion 6f and the second side surface 6i (see FIG. 3) of the rotating member 6 are press-fitted into these groove portions 8c and 8d respectively when the head portion pressing member 8 is mounted on the rotating member 6 along arrow G, as shown in FIG. 7. Thus, the rotating member 6 and the head portion pressing member 8 can also rotate following rotation of the head portion pressing member 7.

As shown in FIGS. 1 and 3, the print head 2 includes the support shafts 2a, a head portion 2b opposed to the platen roller 3 (see FIG. 3), a pair of arm portions 2c coupling the support shafts 2a and the head portion 2b with each other, a heat radiating member 2d of aluminum for radiating heat from the head portion 2b and a head cover 2e (see FIG. 3) of resin mounted on the head portion 2b. The print head 2 is vertically rotatable about the pair of support shafts 2a mounted inside the first and second side surfaces 1a and 1b of the chassis 1 respectively.

A spring holder 29 of sheet metal is fixed to the upper surface of the heat radiating member 2d of the print head 2 with a screw 30, as shown in FIGS. 1 and 6. This spring holder 29 is provided with two spring fixing portions 29a and 29b, and two torsion coil springs 31 and 32 are mounted on these spring fixing portions 29a and 29b respectively. The torsion coil spring 31 has a first end 31a pressed against the pressing portion 7a of the head portion pressing member 7 when the head portion pressing member 7 rotates downward and a second end 31b transmitting urging force resulting from the pressed first end 31a to the head portion 2b, as shown in FIG. 6. The torsion coil spring 32 also has a first end 32a pressed against the pressing portion 8a of the head portion pressing member 8 when the head portion pressing member 8 rotates downward and a second end 32b transmitting urging force resulting from the pressed first end 32a to the head portion 2b. The print head 2 is so formed that the head portion 2b is pressed against the platen roller 3 due to the urging force of the torsion coil springs 31 and 32 transmitted thereto.

As shown in FIGS. 1 and 3, the spring fixing portion 29b of the spring holder 29 is integrally provided with an engaging portion 29d having a notch 29c engaging with the protrusion 8b of the head portion pressing member 8. When the head portion pressing member 8 rotates upward, therefore, the protrusion 8b thereof engages with the notch 29c of the spring fixing portion 29b so that the head portion 2b also rotates upward and separates from the platen roller 3 (see FIG. 1) from the state pressed against the same.

As shown in FIGS. 5 and 6, the driving gear 9 and an intermediate gear 33 are so provided as to transmit the driving force of the stepping motor 19 (see FIG. 2) to the head portion pressing members 7 and 8, thereby rotating the head portion pressing members 7 and 8. The driving gear 9 is mounted on the inner side of the first side surface 1a of the chassis 1, as shown in FIGS. 5 and 6. The intermediate gear 33 and the stepping motor 19 are mounted on the outer side of the first side surface 1a of the chassis 1 through the motor bracket 17, as shown in FIGS. 5 and 6. The driving gear 9 has a minor-diametral gear portion 9a meshing with the gear portion 7b of the head portion pressing member 7 and a major-diametral gear portion 9b meshing with a minor-diametral gear 33a of the intermediate gear 33, as shown in FIG. 5. A major-diametral gear 33b of the intermediate gear 33 meshes with a motor gear 34 of the stepping motor 19, as shown in FIG. 5. Thus, the driving force of the stepping motor 19 is transmitted to the head portion pressing member 8 through the intermediate gear 33 and the driving gear 9 via the head portion pressing member 7 and the rotating member 6.

A motor gear 35 is mounted on the shaft of the stepping motor 18 mounted on the motor bracket 17, as shown in FIG. 4. The stepping motor 18 functions as a driving source for driving a gear portion 16a of the take-up reel 16, the paper feed roller gear 13, the paper discharge roller gear 15 and the feed roller gear 10, as shown in FIG. 5.

The take-up reel 16 is so formed as to take up the ink sheet 51 wound on the take-up bobbin 52b by engaging with the take-up bobbin 52b arranged inside a take-up bobbin storage portion 53b of the ink sheet cartridge 50 described later. The gear portion 16a of the take-up reel 16 is so arranged as to mesh with the swing gear 20 upon swinging thereof, as shown in FIG. 4.

The lower paper guide 11a is set in the vicinity of the feed roller 4 and the press roller 5, as shown in FIG. 3. The upper paper guide 11b is mounted on the upper portion of the lower paper guide 11a. This upper paper guide 11b guides each paper 60 to a paper feed passage toward a printing portion through the lower surface thereof in paper feeding, and guides the same to a paper discharge passage through the upper surface thereof in paper discharge.

The ink sheet cartridge 50 includes the supply bobbin 52a for supplying the ink sheet 51 and the take-up bobbin 52b for taking up the supplied ink sheet 51, as shown in FIG. 1. A cartridge case 53 forming the ink sheet cartridge 50 is constituted of a supply bobbin storage portion 53a rotatably storing the supply bobbin 52a, the take-up bobbin storage portion 53b rotatably storing the take-up bobbin 52b and a pair of coupling portions 53c and 53d coupling the supply bobbin storage portion 53a and the take-up bobbin storage portion 53b with each other at a prescribed distance. When the supply bobbin storage portion 53a and the take-up bobbin storage portion 53b store the supply bobbin 52a and the take-up bobbin 52b respectively, therefore, the ink sheet 51 wound on the supply bobbin 52a and the take-up bobbin 52b is exposed between the supply bobbin storage portion 53a and the take-up bobbin storage portion 53b separating from each other at the prescribed distance. The ink sheet 51 is formed by successively connecting a Y (yellow) ink sheet, an M (magenta) ink sheet and a C (cyan) ink sheet with each other.

A printing operation of the sublimatic printer according to this embodiment is now described with reference to FIGS. 1, 3 to 6 and 12 to 16.

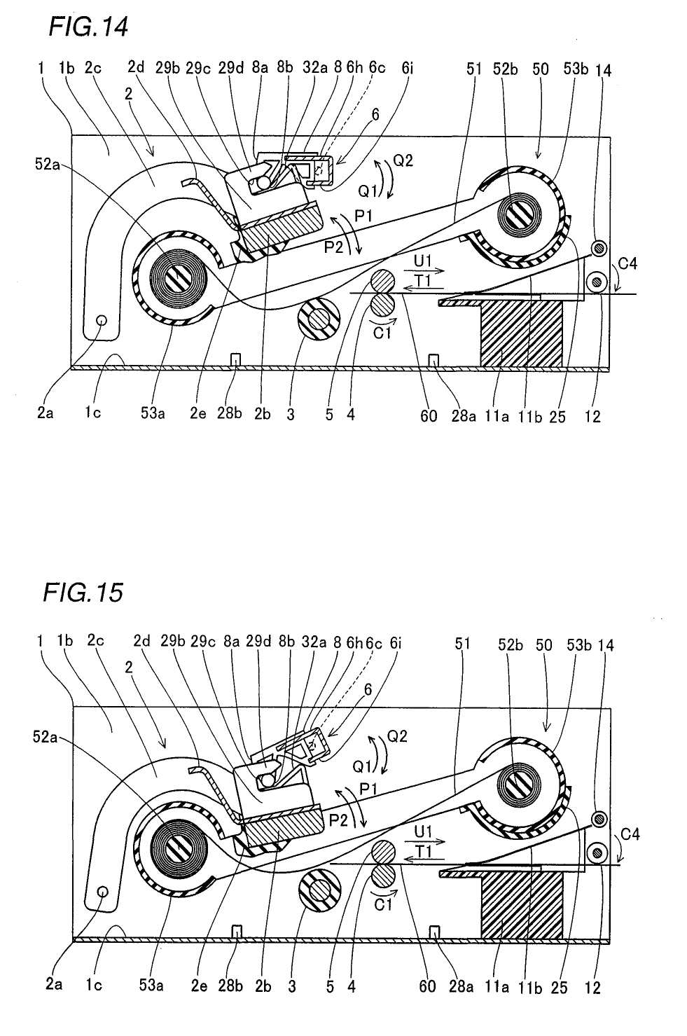

In the state (printing standby state) before starting printing upon power supply to the printer body 90, the head portion 2b of the print head 2 is held on a position separate from the platen roller 3, as shown in FIG. 14. In this case, the protrusion 8b of the head portion pressing member 8 mounted on the rotating member 6 engages with the notch 29c of the engaging portion 29d of the spring fixing portion 29b provided on the upper portion of the head portion 2b, thereby inhibiting the head portion 2b from rotating along arrow P1.

According to this embodiment, the rotating member 6 has rotated about the rotating shafts 6c along arrow Q2 to the rotational position (rotation angle) for the printing standby state and rests thereon while the protrusions 6d provided on the left and right end surfaces 6b of the rotating member 6 are inserted into the engaging portions 1g (see FIG. 1) and 1h (see FIG. 12) provided on the first and second side surfaces 1a and 1b of the chassis 1 thereby engaging with the engaging portions 1g (see FIG. 1) and 1h (see FIG. 12) respectively, as shown in FIGS. 12 and 14. In this case, the rotating shafts 6c of the rotating member 6 are kept in the state supported by the support portion 1e and the support hole 1f provided on the first and second side surfaces 1a and 1b of the chassis 1 respectively, as shown in FIG. 1. Even if the first and second side surfaces 1a and 1b of the chassis 1 are inclined (deformed) outwardly (along arrows E and F in FIGS. 1 and 6) about the portions connected with the bottom surface 1c due to abrupt external force or the like, therefore, the rotating shafts 6c of the rotating member 6 are inhibited from slipping off the support portion 1e and the support hole 1f of the chassis 1 respectively.

When a print button (not shown) or the like is pressed for starting the printing operation, the stepping motor 19 (see FIG. 5) is driven from the initial state (printing standby state) shown in FIG. 14 so that the driving force thereof is transmitted to the gear portion 7b (see FIG. 1) of the head portion pressing member 7 through the motor gear 34 (see FIG. 5), the major- and minor-diametral gears 33b and 33a (see FIG. 5) of the intermediate gear 33 (see FIG. 5) and the driving gear 9 (see FIG. 5) as shown in FIG. 15, whereby the head portion pressing member 7 rotates about the rotating shafts 6c of the rotating member 6 along arrow Q1. At this time, the head portion pressing member 8 (see FIG. 6) mounted on the rotating member 6 along with the head portion pressing member 7 also rotates along arrow Q1 with the head portion pressing member 7. Therefore, the protrusion 8b of the head portion pressing member 8 rotates along arrow Q1, whereby the head portion 2b having been inhibited from rotating along arrow P1 by the protrusion 8b rotates along arrow P1. Thus, the head portion 2b gradually lowers from the separate position, and moves toward the platen roller 3 (pressing side). When the rotating member 6 rotates along arrow Q1 (see FIG. 15) by a prescribed angle, the protrusions 6d of the rotating member 6 also rotate along arrow Q1 and disengage from the engaging portions 1g (see FIG. 1) and 1h of the chassis 1 respectively, as shown in FIG. 13.

As shown in FIG. 3, each paper 60 is transported (fed) toward a printing start position and sensed by the paper sensors 28a and 28b for sensing the front and rear ends thereof. In such paper feeding, the stepping motor 18 is so driven that the motor gear 35 mounted thereon rotates along arrow C3 and the feed roller gear 10 rotates along arrow C1 through the intermediate gears 21 and 22, as shown in FIG. 4. Therefore, the feed roller 4 also rotates along arrow C1. Further, the paper feed roller gear 13 and the paper feed roller 12 rotate along arrow C4 through the intermediate gears 23 and 24. Thus, the paper 60 (see FIG. 3) is transported in the paper feed direction (along arrow T1 in FIG. 3). At this time, the swingable swing gear 20 (see FIG. 4) is not in mesh with the gear 16a of the take-up reel 16, and the gear 16a of the take-up reel 16 remains unrotating. Thus, the take-up bobbin 52b does not take up the ink sheet 51 wound on the supply bobbin 52a (see FIG. 1) in paper feeding.

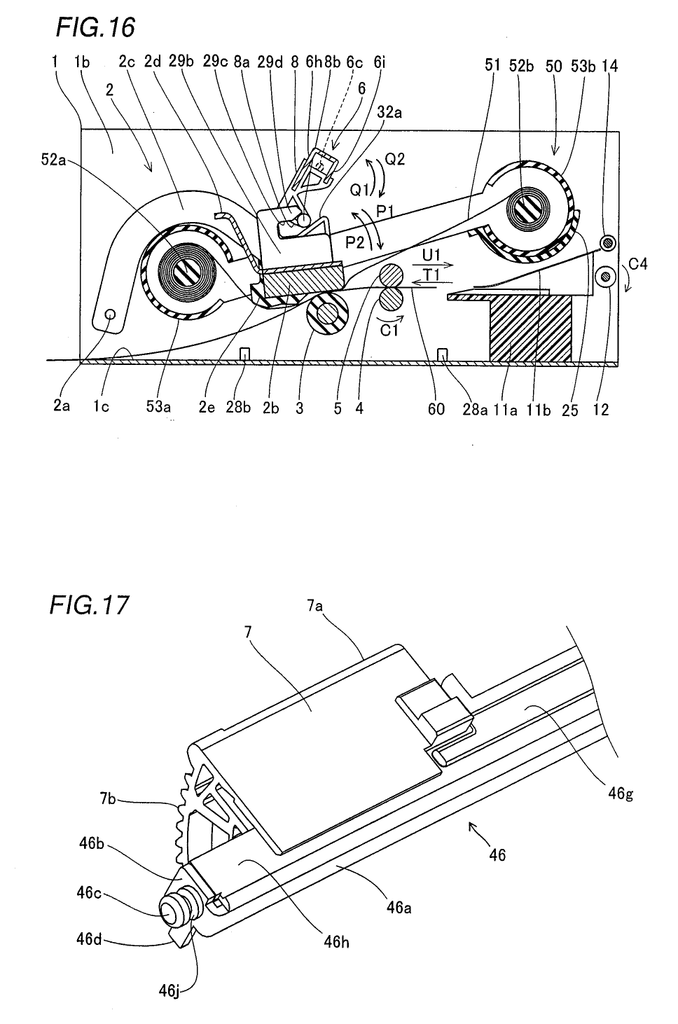

When the print head 2 moves to the pressed position shown in FIG. 16, the head portion pressing members 7 and 8 further rotate along arrow Q1. Thus, the pressing portion 7a of the head portion pressing member 7 presses the first end 31a of the torsion coil spring 31 mounted on the spring holder 29, as shown in FIG. 6. Further, the pressing portion 8a of the head portion pressing member 8 presses the first end 32a of the torsion coil spring 32 mounted on the spring holder 29. At this time, urging force results from the torsion coil springs 31 and 32, and is transmitted to the head portion 2b through the second ends 31b and 32b of the torsion coil springs 31 and 32. Thus, the head portion 2b is pressed against the platen roller 3 through the paper 60 and the ink sheet 51 (Y ink sheet), as shown in FIG. 16. The head portion 2b generates heat, for melting and sublimating ink of the ink sheet 51 (Y ink sheet) and transferring the ink to the paper 60.

Following the driving of the stepping motor 18, the motor gear 35 mounted thereon rotates along arrow D3 and the feed roller gear 10 rotates along arrow D1 through the intermediate gears 21 and 22, as shown in FIG. 4. Thus, the feed roller 4 rotates along arrow D1 in FIG. 4 following the rotation of the feed roller gear 10 (see FIG. 4) thereby transporting the paper 60 in the paper discharge direction (along arrow U1), as shown in FIG. 16. The swingable swing gear 20 swings in the direction (along arrow D2) for meshing with the gear portion 16a of the take-up reel 16 as shown in FIG. 4, to mesh with the gear portion 16a of the take-up reel 16. Therefore, the gear portion 16a of the take-up reel 16 rotates along arrow D4, whereby the take-up bobbin 52b takes up the ink sheet 51 wound on the supply bobbin 52a (see FIG. 16). Thus, the ink is continuously transferred from the ink sheet 51 (Y ink sheet) to the paper 60 transported in the paper discharge direction (along arrow U1).

When the printing with the Y (yellow) ink sheet is completed, the stepping motor 19 (see FIG. 4) is so driven that the driving force thereof is transmitted to the gear portion 7b (see FIG. 1) of the head portion pressing member 7 through the intermediate gear 33 (see FIG. 5) and the driving gear 9 (see FIG. 5). The head portion pressing member 7 (see FIG. 1) rotates about the rotating shafts 6c along arrow Q2, as shown in FIG. 15. At this time, the head portion pressing member 8 (see FIG. 6) mounted on the rotating member 6 along with the head portion pressing member 7 also rotates along arrow Q2 with the head portion pressing member 7. Therefore, the protrusion 8b of the head portion pressing member 8 rotates along arrow Q2, whereby the notch 29c of the spring holder 29 of the print head 2 engaging therewith is lifted up and the head portion 2b of the print head 2 rotates along arrow P2, as shown in FIG. 15. Thus, the head portion 2b of the print head 2 separates from the platen roller 3.

Following driving of the stepping motor 18, the motor gear 35 mounted thereon rotates along arrow C3 and the feed roller gear 10 rotates along arrow C1 through the intermediate gears 21 and 22, as shown in FIG. 4. Thus, the feed roller 4 rotates along arrow C1 following the rotation of the feed roller gear 10 (see FIG. 3) as shown in FIG. 15, for transporting the paper 60 in the paper feed direction (along arrow T1) again so that the paper sensors 28a and 28b sense the paper 60. The swingable swing gear 20 (see FIG. 4) swings in a direction (along arrow C2) for separating from the gear portion 16a of the take-up reel 16 (see FIG. 4). Thus, the take-up bobbin 52b does not take up the ink sheet 51 wound on the supply bobbin 52a but only the paper 60 is transported in the paper feed direction.

Thereafter operations similar to that described with reference to FIGS. 15 and 16 are repeated as to the M and C ink sheets respectively. When printing with all ink sheets constituting the ink sheet 51 is completed, the paper 60 is transported in the paper discharge direction (along arrow U1 in FIG. 15). Then, the head portion 2b of the print head 2 rotates to the separate position in the initial state (printing standby state) along arrow P2 as shown in FIG. 14, for terminating the printing on the paper 60.

According to this embodiment, the rotating member 6 rotates along arrow Q2 up to the rotational position (rotation angle) for the printing standby state and the protrusions 6d provided on the left and right end surfaces 6b of the rotating member 6 are reinserted into the engaging portions 1g (see FIG. 1) and 1h (see FIG. 12) provided on the first and second side surfaces 1a and 1b of the chassis 1 thereby engaging with the engaging portions 1g (see FIG. 1) and 1h (see FIG. 12) respectively, as shown in FIGS. 12 and 14. Also in this case, the rotating shafts 6c of the rotating member 6 are kept in the state supported by the support portion 1e and the support hole 1f provided on the first and second side surfaces 1a and 1b of the chassis 1 respectively. Even if the first and second side surfaces 1a and 1b of the chassis 1 are inclined (deformed) outwardly (along arrows E and F in FIGS. 1 and 6) about the portions connected with the bottom surface 1c due to abrupt external force or the like, therefore, the rotating shafts 6c of the rotating member 6 are inhibited from slipping off the support portion 1e and the support hole 1f of the chassis 1 respectively, similarly to the above.

According to this embodiment, as hereinabove described, the sublimatic printer comprises the printer body 90 having the engaging portions 1g and 1h on the chassis 1 and the rotating member 6 provided with the platelike protrusions 6d engaging with the engaging portions 1g and 1h of the chassis 1 in the nonprinting state of the printer body 90 (in transportation or the printing standby state) so that the protrusions 6d of the rotating member 6 can engage with the engaging portions 1g and 1h of the chassis 1 if the rotating member 6 rotatably supported by the support portion 1e and the support hole 1f of the chassis 1 rests on the rotational position (rotation angle) for the nonprinting state (in transportation or the printing standby state), whereby the rotating member 6 can be kept in the state rotatably supported by the support portion 1e and the support hole 1f of the chassis 1 due to the engagement with the engaging portions 1g and 1h of the chassis 1 even if the first and second side surfaces 1a and 1b of the chassis 1 are inclined (deformed) outwardly (along arrows E and F in FIGS. 1 and 6) about the portions connected with the bottom surface 1c due to an abrupt impact or vibration received from outside the printer body 90. Therefore, the rotating member 6 can be inhibited from slipping off the chassis 1 of the printer body 90 in the nonprinting state (in transportation or the printing standby state). Further, the rotating member 6 integrally includes the rotating shafts 6c provided on the end surfaces 6b as well as the platelike protrusions 6d engaging with the engaging portions 1g and 1h of the chassis 1 so that the printer body 90 may not be provided with rotating shafts for rotating the rotating member 6 or members or mechanisms for engaging with the engaging portions 1g and 1h of the chassis 1 independently of the rotating member 6, whereby the number of components can be inhibited from increase.

According to this embodiment, the engaging portions 1g and 1h are provided on the first and second side surfaces 1a and 1b of the chassis 1 to inwardly protrude into the chassis 1 while the protrusions 6d of the rotating member 6 are inserted into the engaging portions 1g and 1h along with rotation of the rotating member 6 thereby engaging with the engaging portions 1g and 1h respectively, whereby the protrusions 6d of the rotating member 6 having the rotating shafts 6c supported on the first and second side surfaces 1a and 1b of the chassis 1 can easily engage with the engaging portions 1g and 1h provided inside the chassis 1 along with rotation of the rotating member 6.

According to this embodiment, the engaging portions 1g and 1h of the chassis 1 are provided with the position control portions controlling the positions thereof when engaging with the protrusions 6d of the rotating member 6 and these position control portions are arranged substantially parallelly to the first and second side surfaces 1a and 1b of the chassis 1 at the prescribed distance (slightly larger than the thickness of the protrusions 6d) respectively, whereby the position control portions arranged substantially parallelly to the first and second side surfaces 1a and 1b of the chassis 1 come into contact with the protrusions 6d of the rotating member 6 respectively even if the first and second side surfaces 1a and 1b of the chassis 1 are inclined (deformed) outwardly (along arrows E and F in FIGS. 1 and 6) due to an abrupt impact or vibration, thereby controlling the positions of the engaging portions 1g and 1h. Thus, the first and second side surfaces 1a and 1b of the chassis 1 can be easily inhibited from outward inclination (deformation) from the chassis 1 along arrows E and F in FIG. 6.

According to this embodiment, the protrusions 6d of the rotating member 6 are provided on the left and side end surfaces 6b thereof while the engaging portions 1g and 1h of the chassis 1 are provided on the first and second side surfaces 1a and 1b thereof respectively, whereby the protrusions 6d of the rotating member 6 can engage with the engaging portions 1g and 1h of the chassis 1 on the first and second side surfaces 1a and 1b respectively. Therefore, the rotating member 6 can be inhibited from slipping off both of the first and second side surfaces 1a and 1b.

According to this embodiment, the protrusions 6d of the rotating member 6 rotate integrally with the rotating member 6 along the planes substantially parallel to the first and second side surfaces 1a and 1b of the chassis 1 to be inserted into clearances between the first and second side surfaces 1a and 1b of the chassis 1 and the position control portions of the engaging portions 1g and 1h respectively so that the protrusions 6d of the rotating member 6 can rotate in substantially identical planes with respect to the position control portions of the engaging portions 1g and 1h, whereby the protrusions 6d of the rotating member 6 can reliably engage with the engaging portions 1g and 1h of the chassis 1 in an opposed state respectively.

According to this embodiment, the first and second side surfaces 1a and 1b of the chassis 1 are provided with the support portion 1e and the support hole if rotatably supporting the rotating shafts 6c of the rotating member 6 respectively while the engaging portions 1g and 1h of the chassis 1 are provided in the vicinity of the support portion 1e and the support hole if respectively, whereby the rotating shafts 6c of the rotating member 6 and the engaging portions 1g and 1h of the chassis 1 are so approximate that the portions close to the support portion 1e and the support hole if of the chassis 1 can be immediately inhibited from inclination (deformation) resulting from an abrupt impact or vibration when the protrusions 6d of the rotating member 6 engage with the engaging portions 1g and 1h of the chassis 1.

According to this embodiment, the chassis 1 is made of sheet metal and the engaging portions 1g and 1h are integrally provided on the first and second side surfaces 1a and 1b of the chassis 1 by partially uprighting the first and second side surfaces 1a and 1b respectively, whereby the engaging portions 1g and 1h can be formed on the first and second side surfaces 1a and 1b at the same time when the chassis 1 of sheet metal is formed by press working.

According to this embodiment, the engaging portions 1g and 1h of the chassis 1 are so formed that the first sides thereof are connected to the first and second side surfaces 1a and 1b respectively while the second sides corresponding to the rotational direction (substantially obliquely downward direction) of the protrusions 6d of the rotating member 6 are open toward the support portion 1e and the support hole if (obliquely upward direction as viewed from the engaging portions 1g and 1h), whereby the engaging portions 1g and 1h having the open second ends can be improved in strength also when the same are formed by uprighting sheet metal members.

According to this embodiment, the rotating member 6 integrally including the rotating shafts 6c and the protrusions 6d is made of sheet metal, whereby the rotating member 6 (shaft portion 6a) can be prepared from a platelike member previously integrally provided with the protrusions 6d by bending. Further, the rotating shafts 6c can also be easily provided by performing press working such as burring on portions for forming the end surfaces 6b of the rotating member 6 in a pre-step for bending a sheet metal member (rotating member 6).

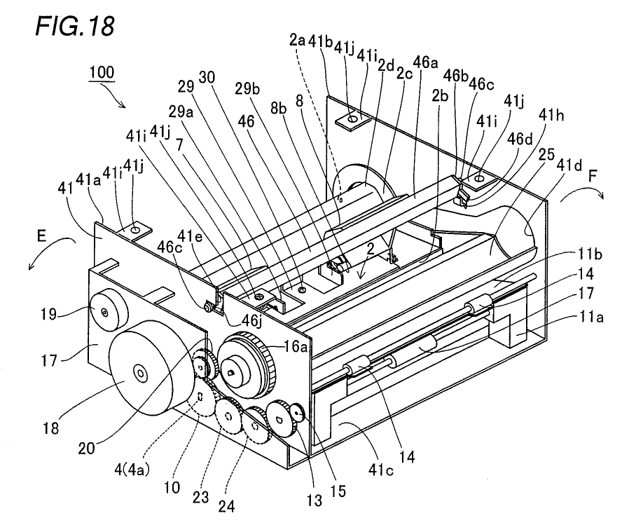

A modification of the sublimatic printer according to the embodiment of the present invention is now described with reference to FIGS. 17 and 18.

In the modification of the sublimatic printer according to the embodiment of the present invention, a rotating shaft 46c, inserted into a support portion 41e (see FIG. 18) of a first side surface 41a (see FIG. 18) of a chassis 41 (see FIG. 18), included in rotating shafts 46c of a rotating member 46 of sheet metal is provided with a circular groove 46j having a smaller diameter than the rotating shaft 46c as shown in FIG. 17, dissimilarly to the aforementioned embodiment. In this case, the first side surface 41a of the chassis 41 is provided with no engaging portion such as the engaging portion 1g (see FIG. 11) of the chassis 1, in the vicinity of a portion located under the support portion 41e, as shown in FIG. 18. The modification of the sublimatic printer is similar in structure to the aforementioned embodiment, except that the rotating shaft 46c is provided with the circular groove 46j and the first side surface 41a of the chassis 41 is provided with no engaging portion.

Also according to this structure of the modification, a protrusion 46d of the rotating member 46 can engage with an engaging portion 41h of the chassis 41 when the rotating member 46 rotatably supported by the support portion 41e and a support hole 41f of the chassis 41 rests on a rotational position (rotation angle) for a nonprinting state (in transportation or a printing standby state), similarly to the state shown in FIG. 12. Further, the groove 46j of the rotating shaft 46c regularly engages with the support portion 41e of the chassis 41 to be inhibited from axial movement regardless of the rotational angle of the rotating member 46 as shown in FIG. 18, whereby the rotating member 46 can be kept in the state supported on the chassis 41 even if the first and second side surfaces 41a and 41b of the chassis 41 are inclined (deformed) outwardly (along arrows E and F) about portions connected with a bottom surface 41c due to an abrupt impact or vibration received from outside a printer body 100. Therefore, the rotating member 46 can be inhibited from slipping off the chassis 41 of the printer body 100 in the nonprinting state (in transportation or the printing standby state), whereby an effect similar to that of the aforementioned embodiment can be attained.

The remaining effects of the modification are similar to those of the aforementioned embodiment.

Although the present invention has been described and illustrated in detail, it is clearly understood that the same is by way of illustration and example only and is not to be taken by way of limitation, the spirit and scope of the present invention being limited only by the terms of the appended claims.

For example, while the aforementioned embodiment is applied to the sublimatic printer employed as an exemplary image generating apparatus, the present invention is not restricted to this but is also applicable to an image generating apparatus other than the sublimatic printer, so far as the image generating apparatus comprises a chassis and a rotating member for rotating a print head or the like.

While the platelike protrusions 6d are integrally provided on the end surfaces 6b of the rotating member 6 in the aforementioned embodiment, the present invention is not restricted to this but rodlike protrusions may alternatively be integrally provided on the end surfaces 6b of the rotating member 6.

While the engaging portions 1g and 1h whose horizontal and vertical sections are both L-shaped are so formed as to inwardly protrude into the chassis 1 by press working in the aforementioned embodiment, the present invention is not restricted to this but engaging portions whose vertical sections alone are L-shaped may alternatively be provided by partially uprighting and bending the chassis 1.

While the engaging portions 1g and 1h of the chassis 1 are integrally provided on the first and second side surfaces 1a and 1b of the chassis 1 respectively in the aforementioned embodiment, the present invention is not restricted to this but engaging portions formed independently of the chassis 1 may alternatively be mounted on the chassis 1.

What is claimed is:

1. An image generating apparatus comprising:
an apparatus body including a chassis having an engaging portion; and
a rotating member, provided inside said chassis, integrally including rotating shafts on both ends thereof while also integrally including a protrusion engaging with said engaging portion of said chassis in a nonprinting state.

2. The image generating apparatus according to claim 1, wherein
said chassis has a first side surface and a second side surface as well as a bottom surface connecting said first side surface and said second side surface with each other,
said engaging portion of said chassis is provided on at least either said first side surface or said second side surface of said chassis to inwardly protrude into said chassis, and
said protrusion of said rotating member is inserted into said engaging portion along with rotation of said rotating member, thereby engaging with said engaging portion.

3. The image generating apparatus according to claim 2, wherein
said engaging portion of said chassis has a position control portion controlling the position of said engaging portion when engaging with said protrusion of said rotating member, and
said position control portion is arranged substantially parallelly to at least either said first side surface or said second side surface of said chassis at a prescribed distance.

4. The image generating apparatus according to claim 1, wherein
said chassis has a first side surface and a second side surface as well as a bottom surface connecting said first side surface and said second side surface with each other, and
said protrusions of said rotating member are provided on both ends of said rotating member, while said engaging portions of said chassis are provided on both of said first side surface and said second side surface.

5. The image generating apparatus according to claim 4, wherein
said engaging portions of said chassis have position control portions controlling the positions of said engaging portions when engaging with said protrusions of said rotating member, and
said protrusions of said rotating member rotate integrally with said rotating member along a plane substantially parallel to at least either said first side surface or said second side surface of said chassis, to be inserted into clearances between at least either said first side surface or said second side surface of said chassis and said position control portions.

6. The image generating apparatus according to claim 1, wherein
said chassis has a first side surface and a second side surface as well as a bottom surface connecting said first side surface and said second side surface with each other,
said first side surface and said second side surface of said chassis are provided with support portions rotatably supporting said rotating shafts of said rotating member, and
said engaging portion of said chassis is provided in the vicinity of said support portions.

7. The image generating apparatus according to claim 1, wherein
said chassis has a first side surface and a second side surface as well as a bottom surface connecting said first side surface and said second side surface with each other, and
said chassis is made of sheet metal, and said engaging portion of said chassis is integrally provided on at least either said first side surface or said second side surface of said chassis by partially uprighting at least either said first side surface or said second side surface.

8. The image generating apparatus according to claim 7, wherein
said rotating member integrally including said protrusion engaging with said engaging portion of said chassis is provided inside said chassis, and
said engaging portion of said chassis is so formed that a first side thereof is connected to at least either said first side surface or said second side surface and a second side corresponding to the rotational direction of said protrusion of said rotating member is open.

9. The image generating apparatus according to claim 1, wherein
said rotating member integrally including said rotating shafts and said protrusion is made of sheet metal.

10. An image generating apparatus comprising:
an apparatus body including a chassis having engaging portions; and
a rotating member of sheet metal, provided inside said chassis, integrally including rotating shafts on both ends thereof while also integrally including protrusions engaging with said engaging portions of said chassis in a nonprinting state, wherein
said chassis is made of sheet metal, and has a first side surface and a second side surface as well as a bottom surface connecting said first side surface and said second side surface with each other,
said engaging portions of said chassis are integrally provided on said first side surface and said second side surface of said chassis by partially uprighting said first side surface and said second side surface of said chassis respectively, to inwardly protrude into said chassis, and
said protrusions provided on both ends of said rotating member are inserted into said engaging portions along with rotation of said rotating member, thereby engaging with said engaging portions.

11. The image generating apparatus according to claim 10, wherein
said engaging portions of said chassis have position control portions controlling the positions of said engaging portions when engaging with said protrusions of said rotating member, and
said position control portions are arranged substantially parallelly to at least either said first side surface or said second side surface of said chassis at prescribed distances.

12. The image generating apparatus according to claim 10, wherein
said engaging portions of said chassis have position control portions controlling the positions of said engaging portions when engaging with said protrusions of said rotating member, and
said protrusions of said rotating member rotate integrally with said rotating member along a plane substantially parallel to at least either said first side surface or said second side surface of said chassis, to be inserted into clearances between at least either said first side surface or said second side surface of said chassis and said position control portions.

13. The image generating apparatus according to claim 10, wherein
said first side surface and said second side surface of said chassis are provided with support portions rotatably supporting said rotating shafts of said rotating member, and
said engaging portions of said chassis are provided in the vicinity of said support portions.

14. The image generating apparatus according to claim 10, wherein
said engaging portions of said chassis are so formed that first sides thereof are connected to at least either said first side surface or said second side surface and second sides corresponding to the rotational direction of said protrusions of said rotating member are open.
